(19) United States
(12) Patent Application Publication
(10) Pub. No.: US 2011/0289835 A1
(43) Pub. Date: Dec. 1, 2011

(54) METHOD AND APPARATUS FOR AQUATIC AGRICULTURE

(76) Inventor: Juventino R. Esparza, Carol Stream, IL (US)

(21) Appl. No.: 12/786,835

(22) Filed: May 25, 2010

(51) Int. Cl. A01G 9/12; A01G 1/00

(52) U.S. Cl. 47/46; 47/58.1 R

(57) ABSTRACT

A system for growing crops on a surface of water may comprise a plurality of growth platforms floating on a body of water; cables for pulling the growth platforms; and rails for guiding the growth platforms as they are pulled in and out of the building. To facilitate planting and harvesting, the platforms may be moved into a building that overlies a portion of a body of water on which the platforms float.

### BACKGROUND OF THE INVENTION

The present invention generally relates to aquatic agriculture.

In modern agricultural systems, irrigation is required in many areas of the world. Many parts of the world do not get exposed to enough natural rainfall to sustain economically viable agriculture. Sources of water for irrigation may be surface water or underground water. In some instances, irrigation water may be collected in ponds, or lakes formed from dammed rivers. When water is held in such open ponds or lakes, evaporation losses may occur. Evaporation losses may be particularly high in regions of the world which are naturally arid.

As can be seen, there is a need for a system of growing crops in a system which evaporation losses of irrigation water is minimized.

### SUMMARY OF THE INVENTION

In one aspect of the present invention, a system for growing crops on a surface of water may comprise; a plurality of growth platforms floating on a body of water; cables for pulling the growth platforms; and rails for guiding the growth platforms as they are pulled.

In another aspect of the present invention, a floatable growth platform may comprise: a plurality of hollow tubes; a layer of permeable cloth overlying the tubes; and a layer of topsoil overlying the permeable cloth.

In still another aspect of the invention a method for growing crops may comprise the steps of: placing a floatable growth platform on a surface of a body of water; planting the crops on the growth platform; and submersing a portion of the growth platform to a predetermined depth so that roots of the crops are at a desired distance from a surface of the body of water.

These and other features, aspects and advantages of the present invention will become better understood with reference to the following drawings, description and claims.

### BRIEF DESCRIPTION OF THE DRAWINGS

FIG. 1A is an elevation view of a floating growth platform in accordance with an embodiment of the invention;

FIG. 1B is a bottom view of the growth platform of FIG. 1A in accordance with an embodiment of the invention;

FIG. 2 is a schematic illustration of a mobility arrangement for the growth platform of FIG. 1A in accordance with an embodiment of the invention;

FIG. 3 is a schematic illustration of a method for moving growth platforms to facilitate planting and/or harvesting in accordance with an embodiment of the invention; and

FIG. 4 is a schematic illustration of an alternate method for moving growth platforms to facilitate planting and/or harvesting in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide for a floating agriculture system in which growth platforms are constructed and floated on a body of water. The platforms may be moved to facilitate planting and harvesting.

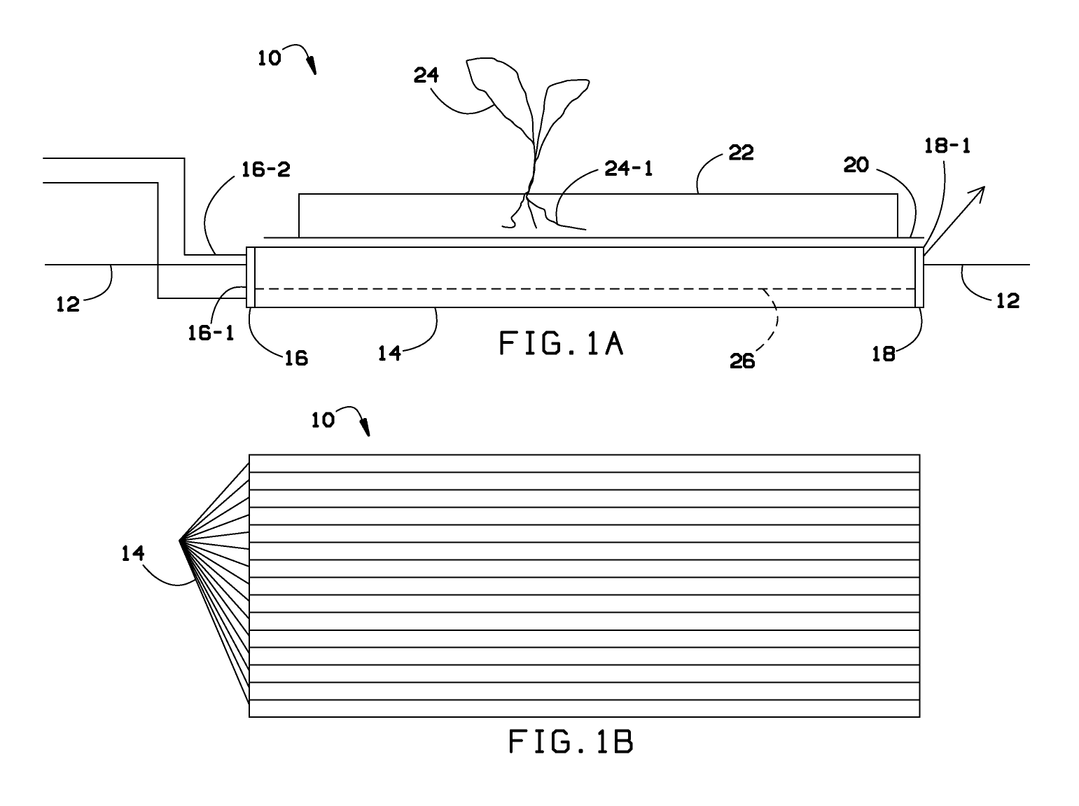

Referring now to FIGS. 1A and 1B, a growth platform 10 is shown floating on water. In an exemplary embodiment the platforms may be about 100 feet in length. The platforms 10 may be square or they may have other rectangular configurations Portions of the platform 10 may be below and above a surface 12 of the water. The platform 10 may comprise hollow float members 14. In an exemplary embodiment of the invention, the float members 14 may comprise polyethylene or ABS pipes. The float members 14 may be provided with end caps 16 and 18. One or more of the end caps 16 may be provided with a water inlet port 16-1 and a compressed-air inlet port 16-2. One or more of the end caps 18 may be provided with an outlet valve 18-1 for ballast water or air

In operation, the growth platform 10 may be covered with a layer of water permeable cloth 20 and a layer of topsoil 22. Plants 24 may be grown in the layer of topsoil 22. The float members 14 may be attached to one another so that water may reach the permeable cloth 20 through capillary action. Roots 24-1 may extract water through the permeable cloth 20.

The growth platform 10 may be variably submergible. Ballast water 26 may be introduced through the ports 16-1 to cause the float members 14 to sink lower relative to the water surface 12. Compressed air may be introduced to blow out the ballast water 26 when it is desired to have growth platform 10 float higher. This flotation level may be varied to accommodate various types of plants.

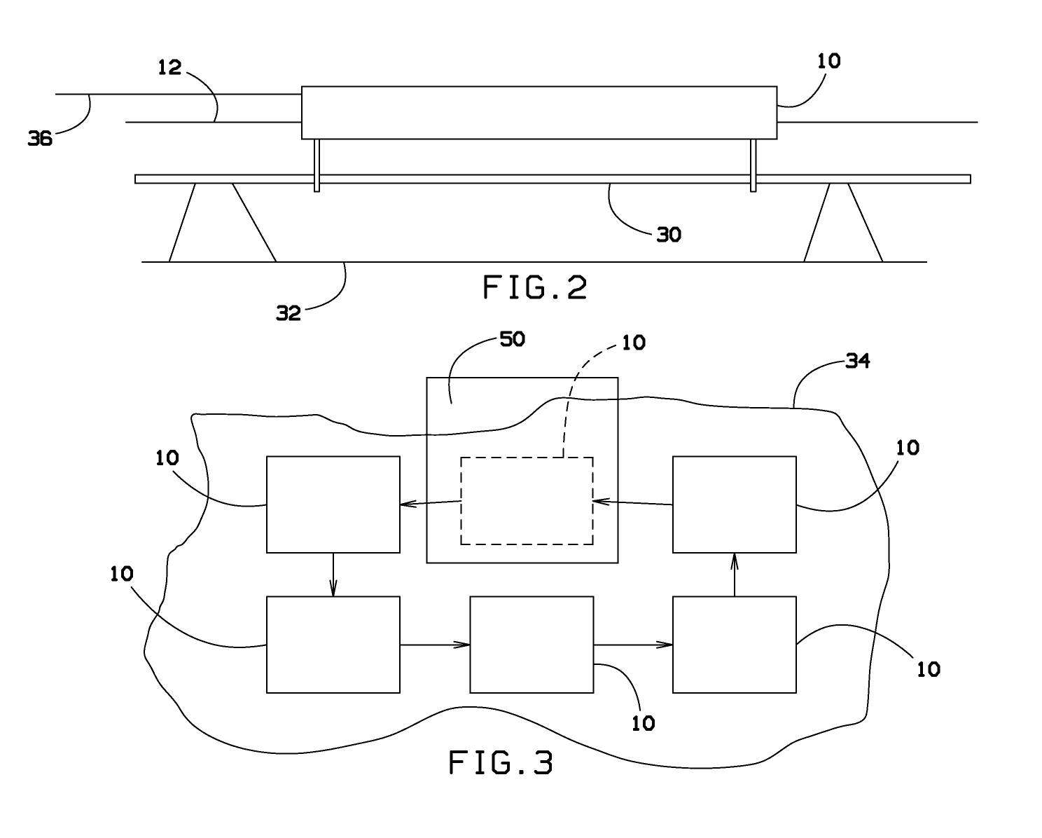

Referring now to FIGS. 2 and 3, it may be seen the growth platform 10 may be attached to a rail 30 which may be supported from a bottom 32 of a body of water 34. A pulling cable 36 may be attached to the growth platform 10 so that the platform 10 may be moved along the rail 30 As shown in FIG. 3, multiple growth platforms 10 may be arranged on the body of water 34 so that they may be pulled successively into a building 50 which may be used for planting and/or harvesting. The building may be constructed to partially overlie both land and a portion of the body of water 34.

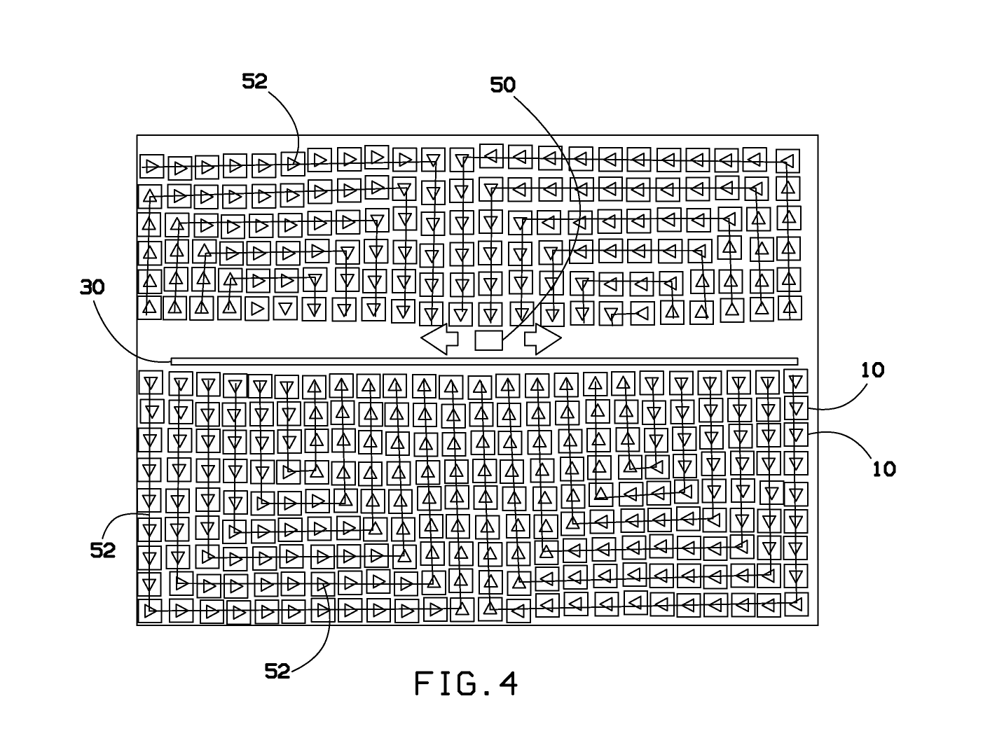

Alternatively, as shown if FIG. 4, the building 50 may be constructed to move on the rails 30 which may be anchored to the bottom 32 of the body of water 34. In such an arrangement the platforms 10 may be detachable from the rails 30 so that they may be moved in accordance with patterned planting and/or harvesting as indicated by traversing paths 52

It should be understood, of course, that the foregoing relates to exemplary embodiments of the invention and that modifications may be made without departing from the spirit and scope of the invention as set forth in the following claims.

We claim:

1. A system for growing crops on a surface of water comprising;
a plurality of growth platforms floating on a body of water;
cables for pulling the growth platforms; and
rails for guiding the growth platforms as they are pulled

2. The system of claim 1 further comprising:
a planting and/or harvesting building partially overlying portions of the body of water; and
wherein the rails pass through the planting and/or harvesting building.

3. The system of claim 2 wherein the planting and/or harvesting building is large enough to overlie at least an entire one of the growth platforms.

4. The system of claim 1 wherein a floating depth of the growth platforms is adjustable.

5. A floatable growth platform comprising:
a plurality of hollow tubes;
a layer of permeable cloth overlying the tubes; and
a layer of topsoil overlying the permeable cloth.

6. The growth platform of claim 5 wherein one or more of the hollow tubes comprise inlets for water and compressed air.

7. The growth platform of claim 6 wherein the one or more hollow tubes further comprise an outlet valve.

8. A method for growing crops comprising the steps of:
placing a floatable growth platform on a surface of a body of water;
planting the crops on the growth platform; and
submersing a portion of the growth platform to a predetermined depth so that roots of the crops are at a desired distance from a surface of the body of water.

9. The method of claim 8 further comprising the steps of:
moving the growth platform into a planting building prior to performing the step of planting; and
moving the growth platform out of the building after planting is complete so that the growth platform is exposed to sunlight.

10. The method of claim 9 further comprising the steps of:
moving the growth platform into the building after plant growth is complete; and
harvesting the crops within the building.
